(19) United States
(12) Patent Application Publication
(10) Pub. No.: US 2025/0297379 A1
(43) Pub. Date: Sep. 25, 2025

(54) FUEL CELL SYSTEM, FUEL CELL PLANT AND PROCESS FOR PRODUCTION OF SYNTHESIS GAS

(71) Applicant: AVL List GmbH, Graz (AT)

(72) Inventors: Manuel TANDL, Graz (AT); Fabian ZAPF, Graz (AT)

(73) Assignee: AVL List GmbH, Graz (AT)

(21) Appl. No.: 18/861,889

(22) PCT Filed: Jun. 22, 2023
(86) PCT No.: PCT/AT2023/060197

§ 371 Date: Oct. 31, 2024

(30) Foreign Application Priority Data
Jun. 23, 2022 (AT) A 50454/2022

(51) Int. Cl. C25B 9/73; C25B 1/23; C25B 3/03; C25B 15/021; C25B 15/08; H01M 8/04014; H01M 8/0656; H01M 8/0668

(52) U.S. Cl. CPC C25B 9/73; C25B 1/23; C25B 3/03; C25B 15/021; C25B 15/08; H01M 8/04022; H01M 8/0656; H01M 8/0668

(57) ABSTRACT

The present invention relates to an electrolysis system (10), an electrolysis plant (30) with an electrolysis system (10) and a synthesis system (20) and a method (1000) for generating synthesis gas by means of the electrolysis system (10).

The present invention relates to an electrolysis system, an electrolysis plant and a method for generating synthesis gas by means of an electrolysis system.

One way to reduce dependence on fossil raw materials and reduce CO2 emissions is to substitute crude oil with synthetic hydrocarbons produced from carbon dioxide (CO2) and water (H2O). By applying electric current, a synthesis gas containing hydrogen (H2) and carbon monoxide (CO) can be generated through high-temperature electrolysis (SOE for short, “Solid Oxide Electrolysis”). In a subsequent synthesis process, the synthetic hydrocarbons are obtained from the synthesis gas.

The object of the present invention is to increase the efficiency of the high-temperature electrolysis described above in a cost-effective and simple manner.

The above object is achieved by an electrolysis system with the features of claim 1, an electrolysis plant with the features of claim 16 and a method with the features of claim 17. Further features and details of the invention are disclosed in the dependent claims, the description and the drawings. Naturally, features and details described in connection with the electrolysis system according to the invention also apply in connection with the electrolysis plant according to the invention and the method according to the invention and vice versa, so that with regard to disclosure mutual reference is or can always be made to the individual aspects of the invention.

According to the invention, an electrolysis system is provided which is in particular designed as an electrolysis system, preferably for carrying out co-electrolysis. The electrolysis system has an electrolysis cell stack with a cathode section comprising a cathode supply section and a cathode discharge section and an anode section comprising an anode supply section and an anode discharge section. Furthermore, the electrolysis system has an anode gas connection fluidically coupled to the anode supply section by means of an anode supply line in order to supply anode gas to the anode section. In addition, the electrolysis system has an anode discharge connection fluidically coupled to the anode discharge section by means of an anode discharge line in order to discharge anode exhaust gases generated by the electrolysis cell stack. Furthermore, the electrolysis system has a cathode supply connection fluidically coupled to the cathode supply section by means of a cathode supply line in order to supply cathode gas to the cathode section. In addition, the electrolysis system has a cathode discharge connection fluidically coupled to the cathode discharge section by means of a cathode discharge line in order to discharge synthesis gas generated by the electrolysis cell stack. The electrolysis system also has a residual gas supply connection to provide residual gas which is separated during synthesis process for the production of synthetic hydrocarbons from the synthesis gas generated by the electrolysis cell stack. The electrolysis system also has two catalysts fluidically coupled to the residual gas supply connection by means of a residual gas supply line and arranged in the anode discharge line for the catalytic combustion of the residual gas. In addition, the electrolysis system has a second heat exchanger and a third heat exchanger which are arranged in the anode discharge line downstream of at least one of the two catalysts in the direction of flow.

According to the invention, the efficiency of an electrolysis system is thus increased in that residual gas from the synthesis process is used to produce synthetic hydrocarbons for catalytic combustion within two catalysts of the electrolysis system. Use is made of the heat generated during catalytic combustion within the electrolysis system by means of at least one heat exchanger. The additional heat can be provided at various locations, in particular connecting lines, most particularly supply lines, such as in particular the anode supply line and/or cathode supply line, in the electrolysis system, thus increasing the efficiency of the high-temperature electrolysis, in particular high-temperature co-electrolysis which is carried out by the electrolysis cell stack in order to generate the synthetic gas or, in other words, synthesis gas. Compared to the use of a single catalyst and parallel heat exchangers, for example, the use of two catalysts has the particular advantage that the second heat exchanger and the third heat exchanger can be supplied with the same amount of heat at lower catalyst temperatures. Higher air and/or reactant temperatures could also be achieved at the same outlet target temperature. These and other advantages of the invention are explained and illustrated in more detail below.

For the sake of simplicity, reference will be made in this description to an electrolysis cell stack. This means at least one electrolysis cell stack, because of course several electrolysis cell stacks may be provided in the electrolysis system which may be interconnected to each other in any way, e.g. they may be connected to each other in series or in parallel. In this case, each cathode section and each anode section of each electrolysis cell stack is fluidically coupled to the connections mentioned herein in the manner described herein.

The electrolysis cell stack can, most particularly, be a solid oxide electrolysis cell stack. Thus, the electrolysis system can in particular be a solid oxide electrolysis system or solid oxide electrolyser cell system (also known as an SOEC system, “Solid Oxide Electrolyser Cell system”). The electrolysis cell stack in the electrolysis system is operated in electrolysis mode, in particular in a co-electrolysis mode, in order to achieve the electrolysis of water (H2O) and carbon dioxide (CO2). In this way, hydrogen gas (H2), carbon monoxide (CO) and oxygen (O2) can be produced by the electrolytes in the electrolysis cell stack. It is advantageous if, in order to generate the synthesis gas, the electrolysis cell stack is connected to a power supply source providing electricity from a renewable energy source. With such a power supply source which is fed from renewable energy sources, the high-temperature electrolysis operation can be made ecologically sustainable.

In the context of the invention, the electrolysis system is in particular also understood to mean an electrolysis system, preferably a co-electrolysis system, and/or a reversible electrolysis system. With a reversible electrolysis system, it is advantageously possible to switch between fuel cell operation and electrolysis operation.

For the reaction described above in electrolysis mode, anode gas, in particular air, most particularly fresh air, or oxygen is supplied to the anode section through the anode supply line. Cathode gas, in particular carbon dioxide, is supplied to the cathode section by means of the cathode supply line. The cathode supply connection can be connected to different carbon dioxide sources. For example, it is possible to extract carbon dioxide from the air, from biogas processes, from industrial exhaust gases, etc. Water can be supplied to the cathode supply section via a first additional supply connection for supplying water. For this purpose, the first additional supply connection, which can be fluidically coupled to the cathode supply line or the cathode supply section by means of a first additional supply line, can supply water to the cathode supply section, preferably in the form of water vapour. Alternatively or additionally, the water in the electrolysis system can be evaporated to water vapour. The water vapour can be considered part of the cathode gas, because it is fed into the cathode supply section. Any shielding gas that is fed into the cathode supply line can also be considered part of the cathode gas because it is fed into the cathode supply section. From the anode discharge section, the anode exhaust gases are discharged to the anode discharge connection by means of the anode discharge line. The anode exhaust gases discharged in the anode discharge line comprise in particular exhaust air or oxygen discharged by the electrolysis system, most particularly air enriched with oxygen, and, downstream of the catalysts, catalyst exhaust gases, i.e. combustion products of the catalytic combustion of the residual gas mixed with the anode exhaust gas. From the anode discharge connection, these can for example be released into the environment. From the cathode discharge section, the generated cathode exhaust gas, which is synthesis gas which in particular mainly contains hydrogen gas and carbon monoxide, is fed to the cathode discharge connection. With a corresponding synthesis system, this can be connected to a synthesis plant in order to provide there the synthetic gas for the production of the synthetic hydrocarbons. In this synthesis process, typically, not all of the synthesis gas can be converted. In addition, the synthesis process produces short-chain hydrocarbons in addition to the long-chain products. The unreacted portion of the synthesis gas, together with the short-chain hydrocarbons, forms a gas mixture which is partly recycled into the synthesis plant and partly separated. This separated gas portion is referred to here as residual gas. Surprisingly, it was found that this residual gas has a high calorific value and can be used advantageously to provide heat in high-temperature electrolysis, as a result of which the efficiency of the electrolysis system can be increased, in particular in the manner according to the invention.

In order to distinguish components or elements of the same kind or type from each other, for example heat exchangers, shut-off devices, partial paths or bypass paths, the components or elements of the same kind or type mentioned in this description are numbered consecutively and are referred to as the first component, second component, third component (or elements), etc., e.g. first heat exchanger, second heat exchanger, etc. This designation on the basis of the numbering serves solely to distinguish between the components or elements of the same kind or type mentioned herein and does not in any way limit the scope of protection. For example, if a claim refers to a fourth component of a kind or type, this does not necessarily presuppose a first, second and third component of this kind or type; unless the first, second and third components of this kind or type are mentioned in a claim on which the claim in question is dependent.

The connection lines mentioned herein are fluid-conveying, in particular gas-conveying connection lines. The connections can be made via different paths or lines, for example pipes or hoses, which are in each case coupled to each other. Various flow-influencing devices may be arranged in the connection lines, as mentioned herein, such as shut-off devices.

Insofar as reference is made herein to an arrangement of a heat exchanger in a connection line and a thermal coupling of the heat exchanger with another connection line, these features are to be understood synonymously because of the function of the heat exchanger. This is because the heat exchanger exchanges the heat from two flows in the respective connection lines, for example in counterflow. In this respect, the heat exchanger is actually arranged in each of the two connection lines and the heat exchanger also thermally couples both connection lines with each other.

Insofar as reference is made herein to control or controlling, in particular in connection with a shut-off device, this is understood to mean controlling and/or regulating. Even if this is not explicitly mentioned, corresponding control electronics and control devices that go beyond shut-off devices, for example flow meters, may be provided for control purposes.

The shut-off devices mentioned herein serve at least to stop or allow the flow of the respective fluid, in particular gas, flowing in the connection lines. Depending on the design type of the shut-off device used, it is also possible to control the flow rate. It is possible to design the shut-off device in a variety of forms, for example as a valve, gate valve, stopcock or butterfly valve.

It is advantageous if the two catalysts are coupled to different, dividing partial paths of the residual gas supply line. In this way, the residual gas flow to each of the two catalysts can be controlled. In other words, the amount of residual gas supplied to each of the two catalysts can be controlled. Consequently, the heat emitted to the heat exchanger arranged downstream of the respective catalyst can also be controlled.

For this purpose, a fifth and/or sixth shut-off device can advantageously be arranged in at least one of the two partial paths. Particularly advantageously, such a shut-off device is arranged in each of the partial paths. For example, a butterfly valve can be used as a shut-off device. This allows a simple yet precise control of the residual gas flow to the catalysts and thus the amounts of heat generated by them through catalytic combustion.

It is also advantageous if each of the two partial paths is fluidically connected to the anode discharge line upstream of a catalyst supply section of one of the two catalysts in order to mix the residual gas and the anode exhaust gas to form a residual gas/anode exhaust gas mixture. Consequently, the residual gas/anode exhaust gas mixture is introduced into the catalysts and catalytically combusted. This not only optimises the catalytic combustion, but also allows the residual gas to be preheated for the catalytic combustion using the warm anode exhaust gas from the electrolysis cell stack.

It can also advantageously be the case that a first catalyst of the two catalysts is arranged downstream of a second catalyst of the two catalysts in the direction of flow of the anode discharge line. Consequently, a first catalyst stage is provided with the first catalyst, and a second catalyst stage is provided with the second catalyst. In particular in connection with the previously mentioned partial paths, each catalyst stage can be individually controlled, for example switched on or off or controlled in terms of the amount of the residual gas supplied, as required for optimal operation of the electrolysis system. Similarly, one of the second and third heat exchangers can be arranged downstream of both catalysts in the direction of flow in the anode discharge line, and another of the second and third heat exchangers can be arranged in the direction of flow in the anode discharge line only after the second catalyst.

It is also advantageous if one of the second and third heat exchangers is thermally coupled to the anode supply line. This allows heat from the catalyst exhaust gases of one or both catalysts to be dissipated to the anode supply line and in this way heat up the anode gas arriving at the anode supply section in order to increase the efficiency of high-temperature electrolysis.

Alternatively or additionally, it can be the case and it is advantageous if one of the second and third heat exchangers is thermally coupled to the cathode supply line. This allows heat from the catalyst exhaust gases of one or both catalysts to be dissipated to the cathode supply line and in this way heat up the cathode gas arriving at the cathode supply section in order to increase the efficiency of the high-temperature electrolysis. Preferably, one of the second and third heat exchangers is used for the thermal coupling with the anode supply line and another for thermal coupling with the cathode supply line.

In addition, it is advantageous if a fourth heat exchanger is arranged downstream of the second and third heat exchanger in the direction of flow in the anode discharge line and is thermally coupled to a first additional supply line which connects the cathode supply line or the cathode supply section with a first additional supply connection for the supply of water or water vapour to the cathode supply section. As a result, the residual heat contained in the catalyst exhaust gas in the anode discharge line after the heat exchange in the second and third heat exchangers can be used to heat the water supplied to the first additional supply connection or the supplied water vapour and thus further increase the efficiency of the electrolysis system.

Additionally or alternatively, it can be the case that, and is advantageous if a fifth heat exchanger is arranged downstream of the second and third heat exchangers in the direction of flow in the anode discharge line and is thermally coupled to the anode supply line. As a result, the residual heat still contained in the exhaust gas in the anode discharge line after the heat exchange in the second and third heat exchanger can be used to heat the air transported in the anode supply line and thus further increase the efficiency of the electrolysis system.

In addition, it is advantageous if a first heat exchanger is arranged in the anode supply line and is thermally coupled to the anode discharge line upstream of the two catalysts in the direction of flow. As a result, in particular in a first step, the heat from the catalyst exhaust gases together with the anode exhaust gas, in particular the discharged air from the anode discharge section, can be used to heat the anode gas, in particular the supplied air. In addition to heating the anode gas, this has the advantage that the anode exhaust gases of the anode section are cooled by the heat transfer, as a result of which the self-ignition temperature of the residual gas/anode exhaust gas mixture which is created by mixing the residual gas and the anode exhaust gas downstream of the first heat exchanger in the direction of flow is not reached, since the anode exhaust gas is very rich in oxygen with approx. 30% oxygen, because oxygen is diffused from the cathode section to the anode section in the electrolysis cell stack. The reduction to below the self-ignition temperature is expedient insofar as a high thermal stress on the components in the electrolysis system is prevented and a controlled combustion via the downstream catalyst is ensured.

It is advantageous if a third bypass path connects the anode supply line upstream of the first heat exchanger in the direction of flow with the anode supply line downstream of the first heat exchanger in the direction of flow, wherein a third shut-off device is arranged in the third bypass path bypassing the first heat exchanger and/or a fourth shut-off device is arranged in the anode supply line downstream of a branch from the anode supply line to the third bypass path and upstream of the first heat exchanger, in the direction of flow. This makes it possible, in a simple manner, for the supplied air in the anode supply line to bypass the first heat exchanger. Furthermore, this allows a simple control of the temperature of the anode gas and the anode exhaust gas in the respective anode connection line.

Advantageously, a first heating device can thereby be arranged in the third bypass path. The first heating device can in particular be an electric heater. In this way, the temperature of the supplied anode gas can be increased even further in order to operate the electrolysis cell stack with optimised operating points.

In addition, the anode discharge line is advantageously connected to the anode supply line by means of a first and/or a second bypass path upstream of at least one of the two catalysts in the direction of flow. In particular, such bypass paths, namely a first bypass path and a second bypass path, can be provided upstream of each of the two catalysts in the direction of flow which are connected to the anode supply line. In this way, in addition to the already performed mixing upstream of the catalysts, in which the oxygen-rich exhaust air of the anode exhaust gas from the anode discharge section is mixed with the residual gas, additional, cool air for the catalytic combustion can in particular be introduced into the catalyst and thus also cool the catalysts. Advantageously, a shut-off device is thereby arranged in the bypass path. Particularly advantageously, a first shut-off device is arranged in the first bypass path and a second shut-off device is arranged in the second bypass path. This makes it possible to control the amount of additional air supplied.

It is also advantageous if at least one of the two catalysts is designed as an oxidation catalyst. In particular, both catalysts can be designed as oxidation catalysts. An oxidation catalyst can oxidise pollutants such as carbon monoxide and hydrocarbons, but it cannot reduce nitrogen oxides. With the help of an oxidation catalyst, not only can the energy contained in the residual gas be used in the form of heat, the hydrogen still present in the exhaust gas can also be converted.

Finally, it is advantageous if the electrolysis system also has a first additional supply connection for the provision of heated water vapour which is heated during cooling, in the synthesis for the production of synthetic hydrocarbons from the synthesis gas generated by the electrolysis cell stack. Accordingly, in order to optimise the efficiency of the electrolysis system, not only the residual gas from the synthesis process but also the heated water vapour produced during cooling during the synthesis process is utilised, as a result of which a double and synergetic optimisation of the efficiency of the high-temperature electrolysis is achieved.

The subject matter of the present invention also includes an electrolysis plant with an electrolysis system according to the invention and a synthesis system with a synthesis plant. The cathode discharge connection is thereby fluidically coupled to the synthesis plant by means of a synthesis gas supply line. The synthesis plant is also configured for the synthesis of the synthetic hydrocarbons produced from the synthesis gas generated by the electrolysis cell stack and supplied by means of the synthesis gas supply line. Finally, the synthesis plant is coupled fluidically to the residual gas supply connection by means of a residual gas discharge line for the provision of residual gas.

In the context of the invention, the electrolysis plant is in particular to be understood as a complete plant which is preferably designed as a so-called “power-to-liquid plant” or PTL plant.

Thus, an electrolysis plant according to the invention brings the same advantages as have been explained in detail with reference to the electrolysis system according to the invention.

The subject matter of the present invention also includes a method for generating synthesis gas by means of an electrolysis system, in particular by means of the electrolysis system according to the invention and, furthermore, most particularly by means of the electrolysis plant according to the invention, comprising the steps:
supplying residual gas separated from a synthesis process in which synthesis gas is converted into hydrocarbons to two catalysts of an electrolysis system,
catalytically combusting the residual gas by means of the two catalysts of the electrolysis system,
transferring heat from a catalyst exhaust gas flow from the catalytic combustion of the two catalysts to an anode gas and a cathode gas by means of two heat exchangers,
supplying the anode gas, cathode gas and electric current to an electrolysis cell stack of the electrolysis system, and
generating the synthesis gas from the supplied anode gas, cathode gas and electric current by means of the electrolysis cell stack.

Thus, a method according to the invention brings the same advantages as have been explained in detail with reference to the electrolysis system according to the invention.

In particular, the electrolysis system and/or the electrolysis plant according to the invention may be configured or designed to carry out the method according to the invention.

The anode gas is understood to be the gas supplied to the anode section, i.e. in particular air or oxygen. This excludes the anode exhaust gas, i.e. the exhaust gas discharged from the anode section, in particular air and/or oxygen. The cathode gas is understood to be the gas supplied to the cathode section, in particular carbon dioxide, water vapour and/or a shielding gas. This excludes the cathode exhaust gas, i.e. the synthetic gas discharged from the cathode section.

It has proven to be advantageous if the residual gas flow is divided into two partial paths and residual gas is in each case supplied to one of the two catalysts by means of one of the two partial paths. As already mentioned above, this allows residual gas flows to the catalysts and thus the amounts of heat transferred between the anode and cathode supply lines to be controlled. Most particularly, it is advantageous that substantially the same amount of heat can be transferred at both heat exchangers and thus to the anode supply line and the cathode supply line in that the residual gas flow in the two partial paths is controlled accordingly.

For this purpose, it is advantageous if the catalyst exhaust gas flow in the two partial paths is controlled by means of a shut-off device in each of the two partial paths downstream of the respective heat exchanger of the respective partial path.

It is also advantageous if the catalyst exhaust gas flow of one of the two catalysts is fed to the other of the two catalysts by means of the anode discharge line. This allows the catalyst exhaust gas flow of one catalyst to be used, in terms of its heat content, for the catalytic combustion of the other catalyst, thus maintaining high efficiency.

Finally, it is preferred that, to achieve a further heat transfer, the catalyst exhaust gas flows flow through a fourth heat exchanger in order to heat water or water vapour supplied to the electrolysis system and/or through a fifth heat exchanger in order to heat the anode gas. This makes it possible to use any remaining residual heat in the catalyst exhaust gas flows of the catalysts to increase the efficiency of the electrolysis system even further.

It is also advantageous if the residual gas is mixed with anode exhaust gas from the electrolysis cell stack gas upstream of the catalysts in the direction of flow to form a residual gas/anode exhaust gas mixture. In this way, the oxygen-rich air of the anode exhaust gas can raise the temperature of the residual gas/anode exhaust gas mixture and can be used for controlled catalytic combustion.

It is thereby advantageous if, before being mixed with the residual gas, the anode exhaust gas transfers heat to the supplied anode gas by means of a first heat exchanger. This allows the supplied anode gas to be heated with the air on the one hand and the anode exhaust gas to be cooled with the air on the other, in particular to below the self-ignition temperature of the residual gas/anode exhaust gas mixture.

Furthermore, it is advantageous if anode gas is mixed into the residual gas/anode exhaust gas mixture. This can be done through the previously mentioned bypass paths, in particular the first and second bypass paths. In this way, the amount of air can be further increased by anode gas containing fresh air in the residual gas/anode exhaust gas mixture.

It has proven to be advantageous if the residual gas/anode exhaust gas mixture has a temperature in the range of 300 to 550° C., in particular in the range of 400 to 500° C. This refers to the temperature at catalyst supply sections of the catalysts. The greatest increase in efficiency in the generation of synthesis gas has been observed in this temperature range.

It is advantageous if the catalyst exhaust gases from the catalytic combustion have a temperature in the range of 800 to 1,000° C., in particular in the range of 850° C. to 950° C. This refers to the temperature at catalyst discharge sections of the catalysts. The greatest increase in efficiency in the generation of synthesis gas has been observed in this temperature range.

Advantageously, the generated synthesis gas is fed into the synthesis process, from which the residual gas is separated and fed to the two catalysts.

It is also advantageous if the synthesis process is a Fischer-Tropsch process. The coupling of high-temperature electrolysis, in particular high-temperature co-electrolysis, and Fischer-Tropsch synthesis (FTS for short) has proven to be a particularly promising variant for the production of different hydrocarbons. In FTS, synthesis gas generated by the high-temperature co-electrolysis is converted into hydrocarbon molecules with different chain lengths at comparatively more moderate temperatures, in particular in the temperature range of 200 to 300° C., and elevated pressures, in particular in the pressure range of 10 to 30 bar, with the help of a catalyst, in particular Co- or Fe-based. The FTS process is highly exothermic. In order to be able to maintain the temperature in the specified temperature range, cooling can be carried out over the length of a reactor in the synthesis plant. Cooling can be carried out with water evaporation at the specified pressure level. The water vapour can then be used for further process steps and, as mentioned above, for the high-temperature electrolysis itself, by adding the water vapour to the cathode gas. The hydrocarbon chain length distribution resulting from FTS is described by a chain growth probability (a high chain growth probability means large molecules and thus a shift towards liquid fuels). However, the synthesis gas is not thereby fully converted. In addition, depending on the chain growth probability, short-chain molecules are produced that cannot be used as liquid fuel. The unreacted synthesis gas and the resulting short-chain hydrocarbons can be separated as the residual gas during the preparation of the product. While some of the residual gas can be recirculated into the FTS, some of it has to be discharged. In particular, the discharged part of the residual gas is used in the method according to the invention.

Further advantages, features and details of the invention are explained in the following description, in which exemplary embodiments are described in detail with reference to the drawings. In each case schematically:

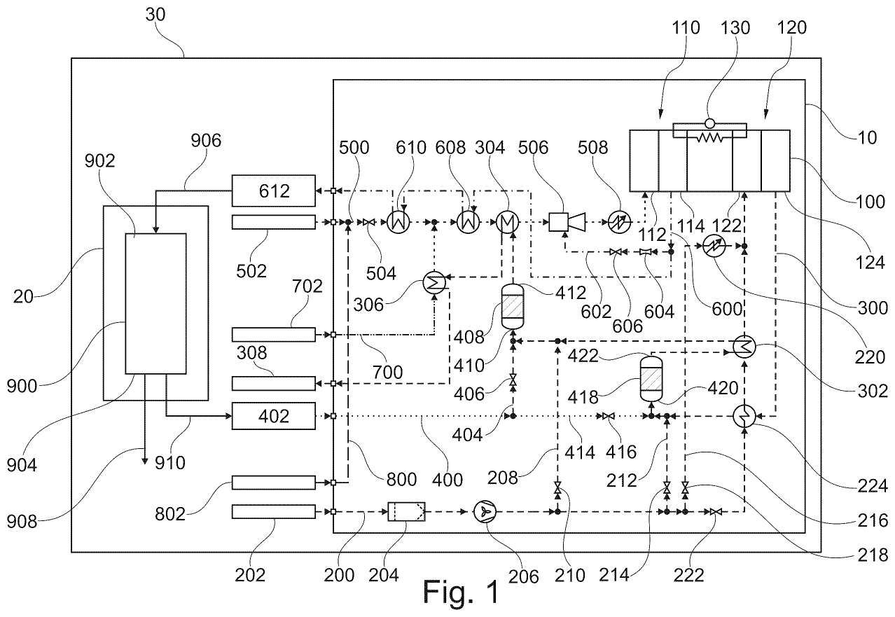

FIG. 1 shows a first embodiment of an electrolysis plant according to the invention,

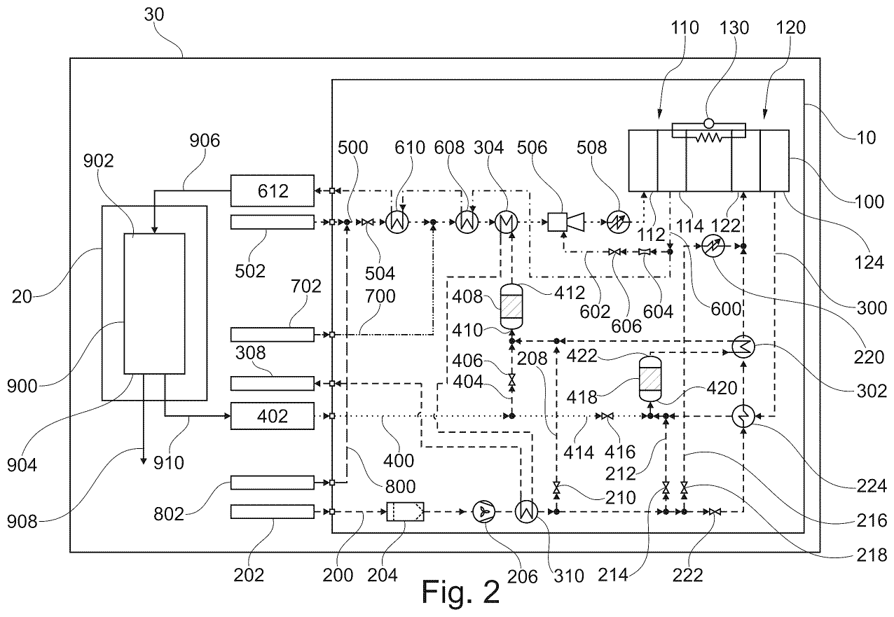

FIG. 2 shows a second embodiment of an electrolysis plant according to the invention,

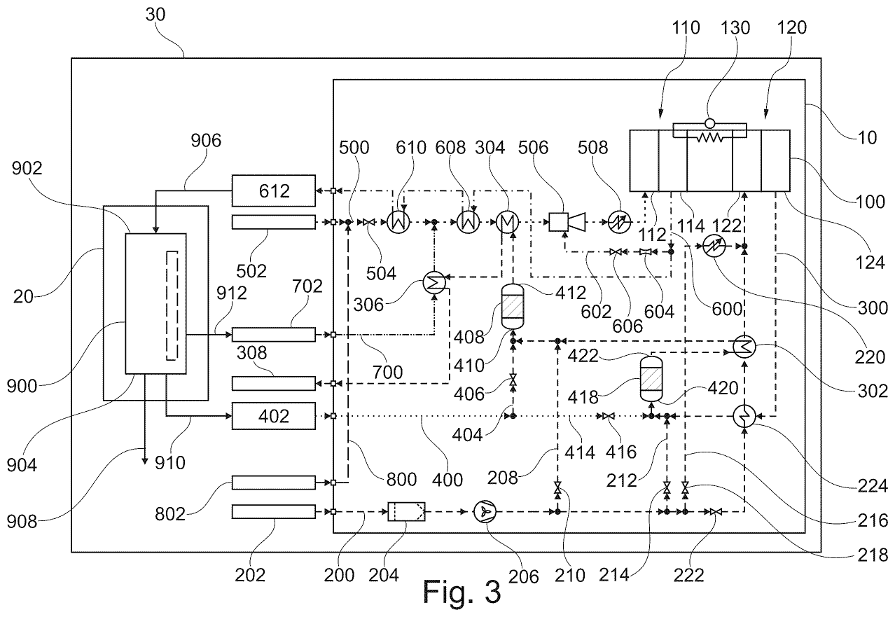

FIG. 3 shows a third embodiment of an electrolysis plant according to the invention, and

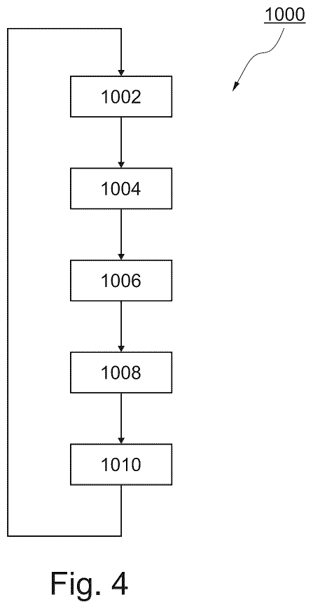

FIG. 4 shows an embodiment of a method according to the invention.

Identical or functionally identical elements are each designated with the same reference sign in FIGS. 1 to 4.

FIG. 1 shows, schematically, an electrolysis plant 30 comprising an electrolysis system 10 with an electrolysis cell stack 100 as well as a synthesis system 20 with a synthesis plant 900. The electrolysis system 10 and the synthesis system 20 are fluidically coupled to each other, as will be explained in more detail later.

As an example, only one electrolysis cell stack 100 is shown in FIG. 1. Nevertheless, it is possible to provide several electrolysis cell stacks 100. The electrolysis cell stack 100 has a cathode section 110 with a cathode supply section 112 and a cathode discharge section 114. Furthermore, the electrolysis cell stack 100 has an anode section 120 with an anode supply section 122 and an anode discharge section 124. A power supply source 130 is connected to the electrolysis cell stack 100 which provides electricity from renewable energies. The electrolysis cell stack 100 is designed as a solid oxide electrolysis cell stack and is used in electrolysis mode for high-temperature co-electrolysis.

By means of an anode gas connection 202, anode gas is provided in the electrolysis system 10 in the form of fresh air. The anode gas is provided at the electrolysis cell stack 100 for electrolysis via an anode supply line 200 which is fluidically coupled to the anode gas connection 202 and the anode supply section 122. A filter device 204, in particular in the form of an air filter, for air filtration and a fan 206 for transporting the anode gas are arranged in the anode supply line 200.

A first heat exchanger 224 is arranged in the anode supply line 200, downstream of the filter device 204 and the fan 206 in the direction of flow of the anode gas from the anode gas connection 202 to the anode supply section 122. The first heat exchanger 224 is used to exchange heat with a warm anode exhaust gas from the electrolysis cell stack 100, in particular in the form of exhaust air discharged from the anode section 120. For this purpose, the first heat exchanger 224 is thermally coupled to an anode discharge line 300 upstream of a second catalyst 418 in the form of an oxidation catalyst. The anode discharge line 300 connects the anode discharge section 124 fluidically to an anode discharge connection 308.

The second catalyst 418 is arranged in the anode discharge line 300 downstream of the first heat exchanger 224 in the direction of flow of the anode exhaust gas and is fluidically coupled to a residual gas connection 402 by means of a residual gas supply line 400. The residual gas connection 402 draws residual gas from the synthesis plant 900, as will be described in more detail later. The residual gas supplied to a second catalyst supply section 420 of the second catalyst 418, which is mixed with the anode exhaust gas in the anode discharge line 300 at a junction of the residual gas supply line 400 with the anode discharge line 300 to form a residual gas/anode exhaust gas mixture, is catalytically combusted by the second catalyst 418. Hot catalyst exhaust gases with a temperature in the range of 800 to 1000° C., in particular around 950° C., are emitted from the second catalyst discharge section 422.

A second bypass path 212 with a second shut-off device 214 arranged therein connects the anode supply line 200 upstream of the first heat exchanger 224 in the direction of flow of the anode gas with the anode discharge line 300 upstream of the second catalyst supply section 420 and thus allows the air content of the residual gas/anode exhaust gas mixture to be further increased before entry into the second catalyst 418 and the residual gas/anode exhaust gas mixture to be cooled further.

In addition, a third bypass path 216 with a third shut-off device 218 is provided which connects the anode supply line 200 upstream of the first heat exchanger 224 in the direction of flow of the anode gas with the anode supply line 200 downstream of the first heat exchanger 224 in the direction of flow of the anode gas, thus making it possible to control the temperature of the residual gas/anode exhaust gas mixture before the second catalyst 418 by regulating the amount of anode gas flowing through the first heat exchanger 224. Furthermore, a fourth shut-off device 222 is arranged upstream of the second heat exchanger 302 and downstream of the third bypass path 216 in the direction of flow.

The hot catalyst exhaust gases of the second catalyst 418 flow out of the second catalyst discharge section 422, in the anode discharge line 300, through a second heat exchanger 302 which is thermally coupled to the anode supply line 200. This allows the heat from the catalyst exhaust gas of the second catalyst 418 to be transferred to the anode gas upstream of the anode supply section 122.

In addition to the second catalyst 418, the electrolysis system 10 also includes another catalyst, referred to here as the first catalyst 408. The first catalyst 408 is arranged in the anode discharge line 300 downstream of the second catalyst 418 in the direction of flow, i.e. downstream of the second heat exchanger 302, and in the catalyst exhaust gas flow of the second catalyst 418. For this purpose, the residual gas supply line 400 is divided into two individual partial paths 404, 414, namely a first partial path 404 and a second partial path 414. A fifth shut-off device 406 is arranged in the first partial path 404. A sixth shut-off device 416 is arranged in the second partial path 414. Accordingly, the amount of residual gas supplied to the respective one of the two catalysts 408, 418, and thus the amount of heat emitted by the catalyst exhaust gases through catalytic combustion, can be controlled by means of the shut-off devices 406, 416. As already explained above, residual gas and anode exhaust gas are mixed at the aforementioned junction before the second catalyst supply section 420 of the second catalyst 418. A corresponding mixing of residual gas and catalyst exhaust gases, which are also referred to here as anode exhaust gas because they flow in the anode discharge line 300, also takes place at a junction where the anode discharge section 300 and the first partial path 404 meet, to form a mixture also referred to here as a residual gas/anode exhaust gas mixture.

A third heat exchanger 304 is arranged in the anode discharge line 300 downstream of the first catalyst 408 and its first catalyst discharge section 412 in the direction of flow. The third heat exchanger 304 is thermally coupled to a cathode supply line 500. The cathode supply line 500 fluidically connects a cathode supply connection 502 to the cathode supply section 112. In the cathode supply line 500, cathode gas, in particular carbon dioxide, is fed from the cathode supply connection 502 to the cathode supply section 112. A seventh shut-off device 504 and an ejector 506 are arranged in the cathode supply line 500 upstream of the cathode section 110 in the direction of flow of the anode gas. Furthermore, a second heating device 508, in this case in the form of an electric heater, is arranged downstream of the ejector 506 in the direction of flow of the anode gas. The cathode gas can be heated with the heat from the catalyst exhaust gas of one or both catalysts 408, 418 by means of the third heat exchanger 304.

A first bypass path 208 with a first shut-off device 210 arranged therein connects the anode supply line 200 upstream of the first heat exchanger 224 in the direction of flow of the anode gas, and in particular before the junction to the second bypass path 212, with the anode discharge line 300 upstream of the first catalyst supply section 410, and thus makes it possible to increase the air content of the residual gas/anode exhaust gas mixture before it enters the first catalyst 408 and to cool the residual gas/anode exhaust gas mixture.

With the arrangement of catalysts 408, 418 in the electrolysis system 10 explained above, it is thus possible to operate only one catalyst or both catalysts 408, 418 together, the latter being preferred. In this way, for controlled catalytic combustion, the oxygen-rich exhaust air in the anode exhaust gas can be fed, mixed with a first quantity of residual gas which can be controlled by means of the sixth shut-off device 416, via the second catalyst 418, which in this respect functions as the first oxidation catalyst stage, to provide heat at the second heat exchanger 302, which acts as an air superheater for the air in the anode gas. Again, for controlled catalytic combustion, the still-oxygen-rich catalyst exhaust gas of the second catalyst 418 can be fed, mixed with a second quantity of the residual gas which can be controlled by means of the fifth shut-off device 406, via the first catalyst 408, which in this respect functions as the second oxidation catalyst stage, to provide heat at the third heat exchanger 304, which acts as a reactant superheater for the cathode gas.

The two oxidation catalyst stages can ensure the same heat exchange at lower oxidation catalyst target temperatures (i.e. the total mass flow through both heat exchangers 302, 304 and the same amount of enthalpy at lower temperatures), or vice versa, as for example in a single-stage system with a parallel arrangement of the two heat exchangers 302, 304. Another advantage is that higher air and reactant temperatures can be achieved at the same oxidation catalyst target temperature.

Alternatively to the arrangement shown in FIG. 1, this interconnection of catalysts 408, 418 in the electrolysis system 10 can also be configured in such a way that the third heat exchanger 304 is arranged in the catalyst exhaust gas flow of the second catalyst 418 and the second heat exchanger 302 is arranged in the catalyst exhaust gas flow of the first catalyst 408. In this respect, it should be noted once again that the designation of components or elements of the same kind or type simply serves here to distinguish them from each other and does not for example follow a technically necessary sequence or the like.

In the embodiment shown in FIG. 1, a fourth heat exchanger 306 is arranged in the anode discharge line 300 downstream of the second heat exchanger 302 in the direction of flow of the catalyst exhaust gas. The fourth heat exchanger 306 is thermally coupled to a first additional supply line 700 which fluidically connects a first additional supply connection 702 to the cathode supply line 500. The first additional supply connection 702 provides water or water vapour for the high-temperature co-electrolysis which is heated by the fourth heat exchanger 306 and flows to the cathode supply line 500.

By means of a cathode discharge line 600 which fluidically connects the cathode discharge section 114 with a cathode discharge connection 612, cathode exhaust gas is discharged to the synthesis system 20 in the form of the synthesis gas generated by the high-temperature co-electrolysis, which contains hydrogen and carbon monoxide. Two heat exchangers 608, 610, namely a sixth heat exchanger 608 and a seventh heat exchanger 610, are arranged in the cathode discharge line 600 and are thermally coupled to the cathode supply line 500 in order to transfer heat from the synthesis gas to the cathode gas and in this way increase the efficiency of the electrolysis system 10.

A fourth bypass path 602 leads from the cathode discharge section 600 to the ejector 506. A nozzle 604, in particular a venturi nozzle, and an eighth shut-off device 606, in particular a valve, is arranged in the fourth bypass path 602.

A second additional supply line 800 fluidically connects a second additional supply connection 802 for supplying a shielding gas to the cathode supply line 500 upstream of the seventh shut-off device 504 in the direction of flow of the cathode supply line 500.

The electrolysis cell stack 100, supplied in the manner described above with anode gas, comprising air, and cathode gas, comprising carbon dioxide, water vapour and shielding gas, generates the cathode exhaust gas in the form of synthesis gas, comprising hydrogen and carbon monoxide, and the anode exhaust gas, comprising exhaust air, in electrolysis mode by high-temperature co-electrolysis. The anode exhaust gas is catalytically combusted by the two catalysts 408, 418 together with residual gas, so that catalyst exhaust gases are separated from the electrolysis system 10 at the anode discharge connection 308.

The synthesis gas is supplied to the synthesis plant 900 of the synthesis system 20 by a synthesis gas supply line 906 which fluidically connects a synthesis supply section 902 of the synthesis plant 900 to the cathode discharge connection 612. In a reactor there, which is not explicitly shown, it undergoes a synthesis process, in particular a Fischer-Tropsch synthesis process, and is converted to synthetic hydrocarbons. The hydrocarbons are discharged via a hydrocarbon discharge line 908 fluidically connected to a synthesis discharge section 904. However, synthesis gas not converted during the synthesis process and short-chain hydrocarbons remain which can be partly fed back into the synthesis process and partly discharged as residual gases by means of a residual gas discharge line 910 to the residual gas supply connection 402, which are accordingly fluidically coupled to each other.

FIG. 2 shows a modification of the embodiment of the electrolysis plant 30 shown in FIG. 1. In FIG. 2, the fourth heat exchanger 306 has been omitted. Instead, a fifth heat exchanger 310 has been inserted in the anode discharge line 300 downstream of the two heat exchangers 302, 304 in the direction of flow which is thermally coupled to the anode supply line 200, in particular downstream of the fan 206 and upstream of the first heat exchanger 224 in the direction of flow of the anode gas. This allows the residual heat in the anode exhaust gas or the catalyst exhaust gas to be provided alternatively for the anode gas. Nevertheless, it is of course also possible to provide both the fourth heat exchanger 306 and the fifth heat exchanger 310, either in series or in parallel connection, with corresponding shut-off devices and bypass paths.

In addition, any configuration of the shown heat exchangers 224, 302, 304, 306, 310, 608, 610 is possible, which means that these heat exchangers can in each case be used in the electrolysis system 10 alone or in any selection from these, so that it is not necessary to equip the electrolysis system 10 with all heat exchangers 224, 302, 304, 306, 310, 608, 610.

FIG. 3 shows a variation of the electrolysis plant 30 of the embodiment shown in FIG. 1, in which modifications have been made in the synthesis system 20. A cooling device is shown in the synthesis plant 900 in dashed lines which in particular cools a corresponding reactor in the synthesis plant 900. Water vapour is used to cool the highly exothermic reaction of the synthesis process. The water vapour heated in this way is advantageously supplied to the first additional supply connection 702 by means of a corresponding third additional supply line 916 which is fluidically connected to the first additional supply connection 702.

FIG. 4 shows the method 1000 for generating synthesis gas by means of the electrolysis system 10 which has already been explained in relation to FIGS. 1 to 3 with reference to the electrolysis plant 30. The method 1000 is shown purely schematically based on its method steps 1002, 1004, 1006, 1008, 1010, whereby further method steps, not explicitly shown, can be added.

In a first method step 1002 of the method 1000, residual gas is separated from the synthesis process taking place in the synthesis plant 900, in which the synthesis gas from the cathode discharge connection 612 is converted into hydrocarbons. The residual gas is supplied to the residual gas supply connection 402 by means of the residual gas discharge line 910 and in this way supplied to the two catalysts 408, 418 by means of the partial paths 404, 414 of the residual gas supply line 400 of the electrolysis system 10.

In the second method step 1004 of the method 1000, a catalytic combustion of the residual gas takes place by means of the two catalysts 408, 418. Corresponding catalyst exhaust gases are emitted from their catalyst discharge sections 412, 422. The catalyst exhaust gases can have a temperature in the range of 800 to 1,000° C. As can be seen in FIGS. 1 to 3, the residual gas upstream of the second catalyst 418 can first be mixed with the anode exhaust gas, i.e. the exhaust air from the electrolysis cell stack 100, and optionally also with the anode gas, i.e. fresh air, by means of the second bypass path 212, so that a residual gas/anode exhaust gas mixture enters the second catalyst supply section 420. As can be seen in FIGS. 1 to 3, the residual gas upstream of the first catalyst 408 can also first be mixed with the anode exhaust gas, i.e. the oxygen-rich catalyst exhaust gas from the second catalyst 418, and optionally also with the anode gas, i.e. fresh air, by means of the first bypass path 208, so that a residual gas/anode exhaust gas mixture enters the first catalyst supply section 410. The residual gas/anode exhaust gas mixture can have a temperature in the range of 300 to 550° C.

In the third method step 1006 of the method 1000, heat from the catalyst exhaust gas flows of the two catalysts 408, 418 from the catalytic combustion is transferred at least to the anode gas in the anode supply line 200 and the cathode gas in the cathode supply line 500 by means of the heat exchangers 302, 304, and advantageously also by means of the fourth heat exchanger 306 and/or the fifth heat exchanger 310.

In a fourth method step 1008 of the method 1000, the anode gases and cathode gases heated in this way are fed into the electrolysis cell stack 100 of the electrolysis system 10 with the supply of electric current. Finally, in the fifth method step 1010, the synthesis gas can be generated by means of the electrolysis cell stack 100 from the supplied anode gas, cathode gas and electric current.

The method steps 1002 to 1010 of the method 1000 are carried out continuously, as indicated by the arrow from method step 1010 to method step 1002.

The above explanations of the embodiments describe the present invention exclusively in the context of examples.

### LIST OF REFERENCE SIGNS

10 electrolysis system
20 synthesis system
30 electrolysis plant
100 electrolysis cell stack
110 cathode section
112 cathode supply section
114 cathode discharge section
120 anode section
122 anode supply section
124 anode discharge section
130 power supply source
200 anode supply line
202 anode supply connection
204 filter device
206 fan
208 first bypass path
210 first shut-off device
212 second bypass path
214 second shut-off device
216 third bypass path
218 third shut-off device
220 first heating device
222 fourth shut-off device
224 first heat exchanger
300 anode discharge line
302 second heat exchanger
304 third heat exchanger
306 fourth heat exchanger
308 anode discharge connection
310 fifth heat exchanger
400 residual gas supply line
402 residual gas supply connection
404 first partial path
406 fifth shut-off device
408 first catalyst
410 first catalyst supply section
412 second catalyst supply section
414 second partial path
416 sixth shut-off device
418 second catalyst
420 second catalyst supply section
422 second catalyst discharge section
500 cathode supply line
502 cathode supply connection
504 seventh shut-off device
506 ejector
508 second heating device
600 cathode discharge line
602 fourth bypass path
604 nozzle
606 eighth shut-off device
608 sixth heat exchanger
610 seventh heat exchanger
612 cathode discharge connection
700 first additional supply line
702 first additional supply connection
800 second additional supply line
802 second additional supply connection
900 synthesis plant
902 synthesis supply section
904 synthesis discharge section
906 synthesis gas supply line
908 hydrocarbon discharge line
910 residual gas discharge line
1000 method
1002 first method step
1004 second method step
1006 third method step
1008 fourth method step
1010 fifth method step

1. Electrolysis system comprising:
an electrolysis cell stack with a cathode section comprising a cathode supply section and a cathode discharge section and an anode section comprising an anode supply section and an anode discharge section,
an anode gas connection fluidically coupled to the anode supply section by means of an anode supply line in order to supply anode gas to the anode section,
an anode discharge connection fluidically coupled to the anode discharge section by means of an anode discharge line in order to discharge anode exhaust gases generated by the electrolysis cell stack,
a cathode supply connection fluidically coupled to the cathode supply section by means of a cathode supply line in order to supply cathode gas to the cathode section, and
a cathode discharge connection fluidically coupled to the cathode discharge section by means of a cathode discharge line in order to discharge synthesis gas generated by the electrolysis cell stack,
wherein
the electrolysis system further comprises:
a residual gas supply connection to provide residual gas which is separated during a synthesis process for the production of synthetic hydrocarbons from the synthesis gas generated by the electrolysis cell stack,
two catalysts fluidically coupled to the residual gas supply connection by means of a residual gas supply line and arranged in the anode discharge line for the catalytic combustion of the residual gas, and
a second heat exchanger and a third heat exchanger which are arranged in the anode discharge line downstream of at least one of the two catalysts in the direction of flow.

2. Electrolysis system according to claim 1, wherein the two catalysts are coupled to different, dividing partial paths of the residual gas supply line.

3. Electrolysis system according to claim 2, wherein a shut-off device is arranged in at least one of the two partial paths.

4. Electrolysis system according to claim 2, wherein each of the two partial paths is fluidically connected to the anode discharge line upstream of a catalyst supply section of one of the two catalysts in order to mix the residual gas and the anode exhaust gas to form a residual gas/anode exhaust gas mixture.

5. Electrolysis system according to claim 1, wherein a first catalyst of the two catalysts is arranged downstream of a second catalyst of the two catalysts in the direction of flow of the anode discharge line.

6. Electrolysis system according to claim 1. wherein one of the second and third heat exchangers is thermally coupled to the anode supply line.

7. Electrolysis system according to claim 1, wherein one of the second and third heat exchangers is thermally coupled to the cathode supply line.

8. Electrolysis system according to claim 1, wherein a fourth heat exchanger is arranged in the anode discharge line downstream of the second and third heat exchangers in the direction of flow and is thermally coupled to a first additional supply line which connects the cathode supply line or the cathode supply section with a first additional supply connection for the supply of water or water vapour to the cathode supply section.

9. Electrolysis system according to claim 1, wherein a fifth heat exchanger is arranged downstream of the second and third heat exchangers in the direction of flow in the anode discharge line and is thermally coupled to the anode supply line.

10. Electrolysis system according to claim 1, wherein a first heat exchanger is arranged in the anode supply line and is thermally coupled to the anode discharge line upstream of the two catalysts in the direction of flow.

11. Electrolysis system according to claim 10, wherein a third bypass path connects the anode supply line upstream of the first heat exchanger in the direction of flow with the anode supply line downstream of the first heat exchanger in the direction of flow, wherein a third shut-off device is arranged in the third bypass path bypassing the first heat exchanger and/or a fourth shut-off device is arranged in the anode supply line downstream of a branch from the anode supply line to the third bypass path and upstream of the first heat exchanger in the direction of flow.

12. Electrolysis system according to claim 11, wherein a first heating device is arranged in the third bypass path.

13. Electrolysis system according to claim 1, wherein the anode discharge line is connected to the anode supply line by means of a bypass path upstream of at least one of the two catalysts in the direction of flow.

14. Electrolysis system according to claim 1, wherein at least one of the two catalysts is designed as an oxidation catalyst.

15. Electrolysis system according to claim 1, wherein the electrolysis system also has a first additional supply connection for the provision of heated water vapour which is heated during cooling, in the synthesis for the production of synthetic hydrocarbons, of the synthesis gas generated by the electrolysis cell stack.

16. Electrolysis plant with an electrolysis system according to claim 1 and a synthesis system with a synthesis plant, wherein
the cathode discharge connection is fluidically coupled to the synthesis plant by means of a synthesis gas supply line,
the synthesis plant is configured for the synthesis of the synthetic hydrocarbons produced from the synthesis gas generated by the electrolysis cell stack and supplied by means of the synthesis gas supply line, and
the synthesis plant is coupled fluidically to the residual gas supply connection by means of a residual gas discharge line for the provision of residual gas.

17. Method for generating synthesis gas by means of an electrolysis system, comprising the steps:
supplying residual gas separated from a synthesis process in which synthesis gas is converted into hydrocarbons to two catalysts of an electrolysis system,
catalytically combusting the residual gas by means of the two catalysts of the electrolysis system,
transferring heat from catalyst exhaust gas flows from the catalytic combustion of the two catalysts to an anode gas and a cathode gas respectively by means of two heat exchangers,
supplying the anode gas, cathode gas and electric current to an electrolysis cell stack of the electrolysis system, and
generating the synthesis gas from the supplied anode gas, cathode gas and electric current by means of the electrolysis cell stack.

18. Method according to claim 17, wherein the residual gas flow is divided into two partial paths and residual gas is in each case supplied to one of the two catalysts by means of one of the two partial paths.

19. Method according to claim 18, wherein the supply of the residual gas flow to each of the two catalysts is in each case controlled by means of a shut-off device in each of the two partial paths.

20. Method according to claim 17, wherein the catalyst exhaust gas flow from one of the two catalysts is fed to the other of the two catalysts by means of the anode discharge line.

21. Method according to claim 17, wherein to achieve a further heat transfer, the catalyst exhaust gas flows flow through a fourth heat exchanger in order to heat water or water vapour supplied to the electrolysis system and/or through a fifth heat exchanger in order to heat the anode gas.

22. Method according to claim 17, wherein the residual gas is mixed with anode exhaust gas from the electrolysis cell stack upstream of the catalysts in the direction of flow to form a residual gas/anode exhaust gas mixture.

23. Method according to claim 22, wherein before being mixed with the residual gas, the anode exhaust gas transfers heat to the supplied anode gas by means of a first heat exchanger.

24. Method according to claim 22, wherein anode gas is mixed into the residual gas/anode exhaust gas mixture.

25. Method according to claim 22, wherein the residual gas/anode exhaust gas mixture has a temperature in the range of 300 to 550° C.

26. Method according to claim 17, wherein the catalyst exhaust gases from the catalytic combustion have a temperature in the range of 800 to 1,000° C.

27. Method according to claim 17, wherein the generated synthesis gas is fed into the synthesis process, from which the residual gas is separated and fed to the two catalysts.

28. Method according to claim 17, wherein the synthesis process is a Fischer-Tropsch process.
